(19) United States
(12) Patent Application Publication
(10) Pub. No.: US 2025/0048415 A1
(43) Pub. Date: Feb. 6, 2025

(54) Network Energy Savings in Multi-Radio Access Technology Networks

(71) Applicant: Dell Products L.P., Round Rock, TX (US)

(72) Inventors: Jeebak Mitra, Ottawa (CA); Gwenael Poitau, Montreal (CA)

(21) Appl. No.: 18/364,444

(22) Filed: Aug. 2, 2023

(51) Int. Cl. H04W 72/542; H04B 17/318; H04W 24/02; H04W 48/18

(52) U.S. Cl. CPC H04W 72/542; H04B 17/318; H04W 24/02; H04W 48/18

(57) ABSTRACT

A method can comprise receiving, by a system, a service request from a user equipment. The method can further comprise, based on the service request, determining respective signal strengths of respective radio access technologies of multiple radio access technologies being used for cellular broadband communications. The method can further comprise, identifying a subset of the respective radio access technologies for which a signal strength criterion is satisfied. The method can further comprise processing a subset of the respective signal strengths corresponding to the subset of the respective radio access technologies using a machine learning model to determine a selected radio access technology, wherein the machine learning model is trained to determine the selected radio access technology based on an energy efficiency metric of the system and based on resource allocation of the system. The method can further comprise communicating with the user equipment via the selected radio access technology.

### BACKGROUND

A base station can communicate with user equipment (UE) to facilitate mobile communications, or cellular network communications. In doing so, the base station can consume energy.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method can comprise receiving, by a system, a service request from a user equipment. The method can further comprise, based on the service request, determining, by the system, respective signal strengths of respective radio access technologies of multiple radio access technologies being used for cellular broadband communications. The method can further comprise, identifying, by the system, a subset of the respective radio access technologies for which a signal strength criterion is satisfied. The method can further comprise processing, by the system, a subset of the respective signal strengths corresponding to the subset of the respective radio access technologies using a machine learning model to determine a selected radio access technology of the multiple radio access technologies, wherein the machine learning model is trained to determine the selected radio access technology based on an energy efficiency metric of the system and based on resource allocation of the system. The method can further comprise communicating, by the system, with the user equipment via the selected radio access technology.

An example system can operate as follows. The system can receive a service request from a user equipment, wherein the service request corresponds to facilitating cellular broadband communications. The system can, based on the service request, determine respective signal strengths of respective radio access technologies of a group of multiple radio access technologies usable for the cellular broadband communications. The system can identify a subset of the respective radio access technologies for which corresponding signal strengths satisfy a signal strength criterion. The system can process the corresponding signal strengths of the subset of the respective radio access technologies with a trained machine learning model to determine a selected radio access technology of the group of multiple radio access technologies, wherein the trained machine learning model is configured to determine the selected radio access technology based on an energy efficiency metric of the system and based on resource allocation of the system. The system can communicate with the user equipment using the selected radio access technology.

An example non-transitory computer-readable medium can comprise instructions that, in response to execution, cause a system comprising a processor to perform operations. These operations can comprise, based on receiving a service request from a user equipment, determining respective signal strengths of respective radio access technologies of a group of multiple radio access technologies. These operations can further comprise identifying a subset of the respective radio access technologies for which a corresponding subset of the respective signal strengths satisfies a signal strength criterion. These operations can further comprise processing the respective signal strengths of the subset of the respective radio access technologies with an artificial intelligence model to determine a selected radio access technology of the group of multiple radio access technologies, wherein the artificial intelligence model is trained to determine the selected radio access technology based on an energy efficiency metric of the system and based on resource allocation of the system. These operations can further comprise communicating with the user equipment using the selected radio access technology.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate network energy savings in multi-radio access technology (RAT) networks, in accordance with an embodiment of this disclosure;

FIG. 2 illustrates an example system architecture for an integrated multi-RAT architecture that considers a colocation based on functionality, and that can facilitate network energy savings in multi-RAT networks, in accordance with an embodiment of this disclosure;

FIG. 3 illustrates an example system architecture for artificial intelligence/machine learning (AI/ML)-based RAT selection based on energy efficiency, and that can facilitate network energy savings in multi-RAT networks, in accordance with an embodiment of this disclosure;

FIG. 4 illustrates an example power consumption modeling for a multi-RAT base station (BS) deployment with a shared power amplifier (PA), and that can facilitate network energy savings in multi-RAT networks, in accordance with an embodiment of this disclosure;

FIG. 5 illustrates an example system architecture for a load-balanced multi-RAT base station selection with energy efficiency, and that can facilitate network energy savings in multi-RAT networks, in accordance with an embodiment of this disclosure;

FIG. 6 illustrates an example process flow that can facilitate network energy savings in multi-RAT networks in base stations, in accordance with an embodiment of this disclosure;

FIG. 7 illustrates another example process flow that can facilitate network energy savings in multi-RAT networks in base stations, in accordance with an embodiment of this disclosure;

FIG. 8 illustrates another example process flow that can facilitate network energy savings in multi-RAT networks in base stations, in accordance with an embodiment of this disclosure;

FIG. 9 illustrates an example process flow for training a model with a reinforcement learning agent, and that can facilitate network energy savings in multi-RAT networks in base stations, in accordance with an embodiment of this disclosure;

FIG. 10 illustrates an example block diagram of a wireless communications operating environment operable to execute an embodiment of this disclosure.

### DETAILED DESCRIPTION

### Overview

While the examples described herein generally describe specific types of mobile networks, it can be appreciated that the present techniques can be applied to other types of networks. Where optimal results, or optimization techniques, are described, it can be appreciated that these can more generally apply to improvements in examples, such as improvements that satisfy an optimization criterion. A similar approach can be applied to other examples that mention superlatives, such as maximum or least.

Energy consumption of mobile networks can be an important issue for current and next generation networks. In some areas, there has been increasing focus on the use of energy efficient methods, in both the design and operation of mobile networks. The third generation partnership project (3GPP) standards play a key role in defining the requirements and features of multiple generations of mobile networks in conjunction with bodies such as the international telecommunications union (ITU) that provides the objectives for each generation prior to the deliberations on the design of various layers within the standards sub-groups of 3GPP. While specifications from each release can have maintained some notion of backwards compatibility since moving to an orthogonal frequency division multiplexing (OFDM)-based transmission for the 3GPP long term evolution (LTE) specification for the fourth generation (4G), generations prior to it have used different waveforms and core network architecture. Therefore, second generation (2G) and third generation (3G) networks coexisting within the same geographical area can involve a use of different frequency bands using different network equipment due to fundamental differences between the protocol stacks of the various generations. Currently, with the advent of 5G NR, there are proposed features geared towards energy efficiency that can be applicable to what is known as the standalone (SA) implementation. Nonetheless, a practical reality can continue to be the fact that networks from multiple generations continue to coexist, and while there can be plans to accelerate shutting down some of the previous generation mobile networks to free up valuable spectrum for use, the process can be gradual. Therefore, it can be a while before older generation networks give way to more efficient newer generation technology. Furthermore, future generations of mobile networks such as the sixth generation (6G) may also need to consider the coexistence with both 4G and 5G networks going forward. Consequently, approaches to applying energy-saving features across the several generations of mobile networks simultaneously can be a valuable feature that mobile network operators (MNOs) look for.

Mobile networks have evolved over several generations during the course of their usage and is currently onto a fifth generation, or 5G. Over these multiple generations, transmission speeds increased manifold from the second generation mobile networks based on a global system for mobile communications (GSM) standard, to third generation networks based on code division multiple access (CDMA) or wideband-CDMA (W-CDMA), giving rise to enhanced data rates for GSM evolution (EDGE) and high speed packet access (HSPA) standards.

Subsequently, OFDM based networks became a mainstay of mobile network air interface starting from 4G networks to 5G NR, with a host of advanced features that facilitate high-speed low latency data transfers. Traditionally, newer radio access network (RAN) infrastructures have been deployed alongside existing ones, with each new cellular technology roll-out. This deployment strategy can allow for a gradual deployment of new technologies, spreading capital expenditure (CAPEX) over time, and extend a return on investment (ROI) for older network infrastructure. Nonetheless, with the increased capacity, it can be that energy consumption of the networks has also increased exponentially, and thus poses a heavy burden on network operational expenditures (OPEX) along with detrimental effects that the energy consumption has on the environment to produce such large amounts of energy. A transition from one generation to another is generally not universal, and often times a current generation of network equipment can coexist with at least one generation prior to that. In fact, an overall power consumption can rise significantly in deploying a new generation, as more energy is necessary to keep more extensive cellular networks operating.

In some examples, for consolidation and seamless integration, existing 2G and 3G base stations have been replaced with newer infrastructure that run 2G, 3G, and 4G from single radio hardware, and this can be referred to as Multi-Radio Access Technology (M-RAT). M-RAT can generally comprise a co-location of multiple cellular standards into single radio items. In some examples of an M-RAT architecture, communication technology can be any of the RATs such as GSM, W-CDMA, LTE, 5G NR, and Wi-Fi as well. With the advent of 5G and with particular attention to dual connectivity, as outlined in the 3GPP 5G specification, an M-RAT architecture can receive increased attention. Concurrent connectivity to multiple cellular RATs can present a set of issues, such as joint M-RAT assignments, and dynamic power allocation, which has been addressed in some prior approaches statistically by observing mobile equipment behavior with respect to accessing multiple RATs, or a single one.

In some configurations, each RAT in each sector utilizes its own PA and, hence, a multi-RAT site can contain a large number of PAs. When a cell site uses multi-input multi-output (MIMO), and, possibly, multiple frequency bands, a number of PAs can quickly become quite large. Given that PAs can be the most power consuming components in a macro base station, and the fact that they can consume a considerable amount of energy even when carrying no traffic, it can be seen that multi-RAT deployments can lead to an increased concern regarding total energy consumption. Total energy consumption can be a primary driver of equipment footprint at the cell site, and can constitute a large fraction of operators' OPEX. The reported energy consumption of radios can vary depending on numerous factors, such as source, technology, cell size, components, manufacturers, configuration, and radiating power. In general, it can be that the older the cellular technology, the more the energy required to power a single radio. For example, a single 2G GSM base station can require an average power of 3.8 kilowatts (KW) for an annual energy amount of around 33.3 megawatt hours (MWh). A single 3G base station can instead require 1 KW, for an annual consumption of 9 MWh. Values for an LTE base station can be around 0.5 KW, resulting in an annual consumption of 4.5 MWh. However, it can be that this does not take into account reducing cell coverage of successive generations as densification can be a primary way to enhance network capacity. While an LTE base station can have a spectral efficiency that is 30-40 times that of a 2G base station, to offer the same coverage of the latter, an LTE network can consume even more energy.

Furthermore, one or more RATs can also be able to share a PA within multi-RAT radio base stations, in which the radio units can support more than one RAT simultaneously. For such multi-RAT configurations, the radio unit and the power amplifier can be shared between the RATs. The energy consumption in such configurations can be explored using system level simulations with different traffic and transmission environments using certain standardized energy consumption evaluation frameworks. For modern transceiver designs, however, such models can be outdated due to significant advancements in both PA design and state-of-art radio circuitry.

In 5G NR, a rigorous effort can have been made to ensure a higher level of energy efficiency which, even compared to 4G-LTE base stations, can be significantly more than previous generations. For example, for discontinuous transmission (DTX), a concept that was introduced for 4G networks, longer durations and higher ratio of discontinuous transmission (DTX) can be supported in NR compared to a 3GPP LTE standard. Additionally, higher transmission rates of 5G NR can additionally result in even more DTX opportunities, as packet transmission times decrease. These features can allow for implementation of new deep-sleep states for RAN hardware such that the base station can lower its total energy usage significantly. However, a use of certain advanced features of NR can also imply that the required number of base stations for coverage of a similar sized area can potentially be greater than 4G-LTE base stations, and far greater than 2G and 3G. It can be that 2G signals can provide far greater coverage, and thus can be a network of choice for internet of things (IoT) and telematics applications. While it can be that benefits of 5G networks cannot be retrofitted to older networks due to lack of backwards compatibility beyond 4G, a multi-RAT deployment can still be optimized to provide benefits of disparate technologies to users by optimal network selection, and providing a data-driven approach to operational policy optimization. The present techniques can be implemented to increase overall energy efficiency of the network.

The present techniques can be implemented to improve NES for multi-RAT mobile networks by using ML based decision making. The present techniques can also be implemented to facilitate deciding on which mode to operate each RAT in when selected to service a certain set of requests, so as to not violate service level agreements using a network-centric approach. The present techniques can be implemented to provide an online learning approach to incorporate feedback received from in-field operations to improve upon energy savings. The present techniques can also be implemented to provide network operators with a framework that can be used for an integrated approach to network resource management for multi-constraint operation without affecting coverage. The present techniques can also be implemented to facilitate an optimal association of UEs with the base station/RAT based on their preferences (requested QoS, data rate, and contract) for efficient utilization of the available radio resources with an energy efficiency optimization constraint.

### Example Architectures

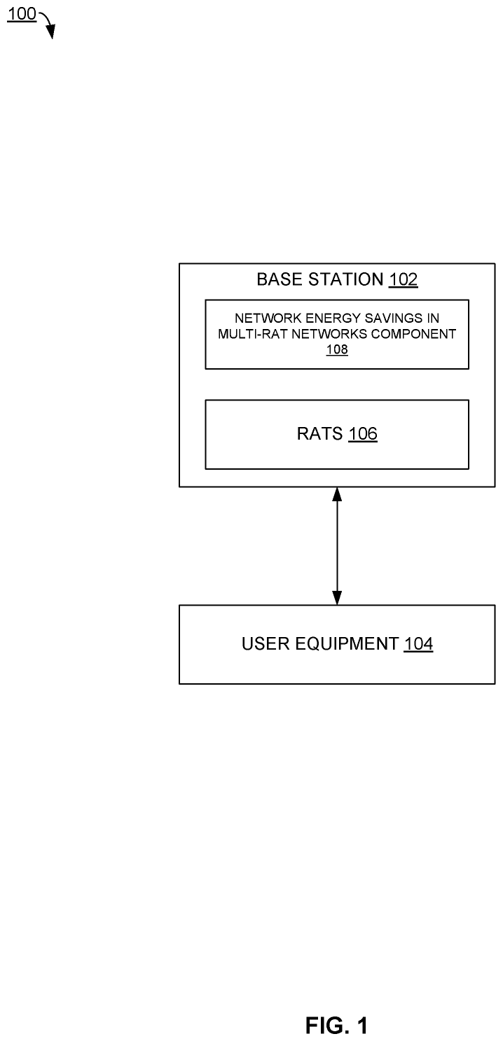

FIG. 1 illustrates an example system architecture 100 that can facilitate network energy savings in multi-RAT networks in base stations in accordance with an embodiment of this disclosure.

System architecture 100 comprises base station 102, and user equipment 104. In turn, base station 102 comprises RATs 106, and network energy savings in multi-RAT networks component 108.

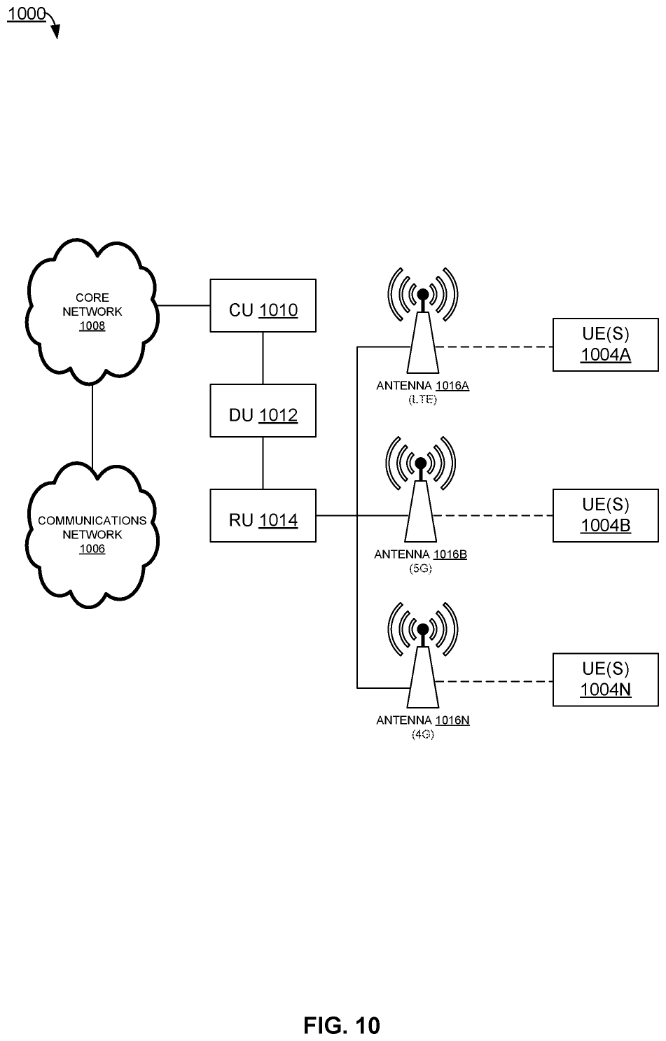

Each of base station 102 and/or user equipment 104 can be implemented with part(s) of wireless communications operating environment 1000 of FIG. 10. Base station 102 can generally comprise one or more antennas and electronic communications equipment to facilitate network communications with user equipment 104. User equipment 104 can generally comprise a computing device used by an end user to communicate with base station 102.

As part of communicating with user equipment 104 (including examples of communicating with multiple user equipment devices), base station 102 can determine a RAT with which to communicate with the UE, where the UE is configured to communicate via multiple RATs of RATs 106. Determining which RAT to use can be performed to minimize energy consumption in base station 102, while also satisfying quality-of-service (QOS) metrics with regard to user equipment 104, and also with regard to other user equipment that is communicating with base station 102.

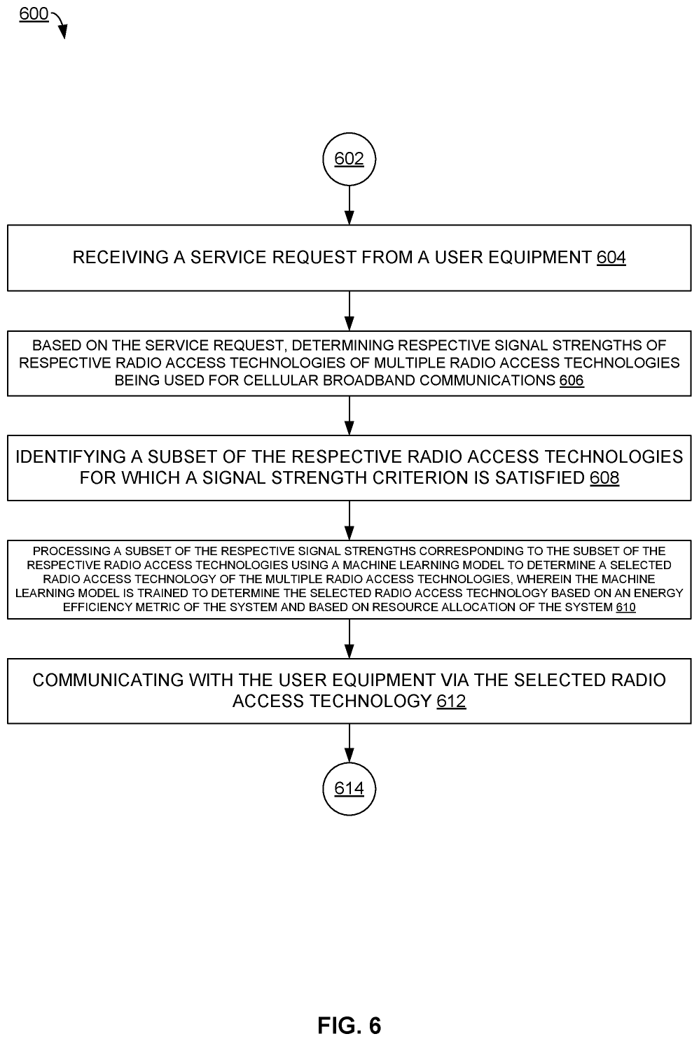

In some examples, network energy savings in multi-RAT networks component 108 can implement part(s) of the process flows of FIGS. 6-9 to implement network energy savings in multi-RAT networks in base stations.

It can be appreciated that system architecture 100 is one example system architecture for network energy savings in multi-RAT networks, and that there can be other system architectures for network energy savings in multi-RAT networks.

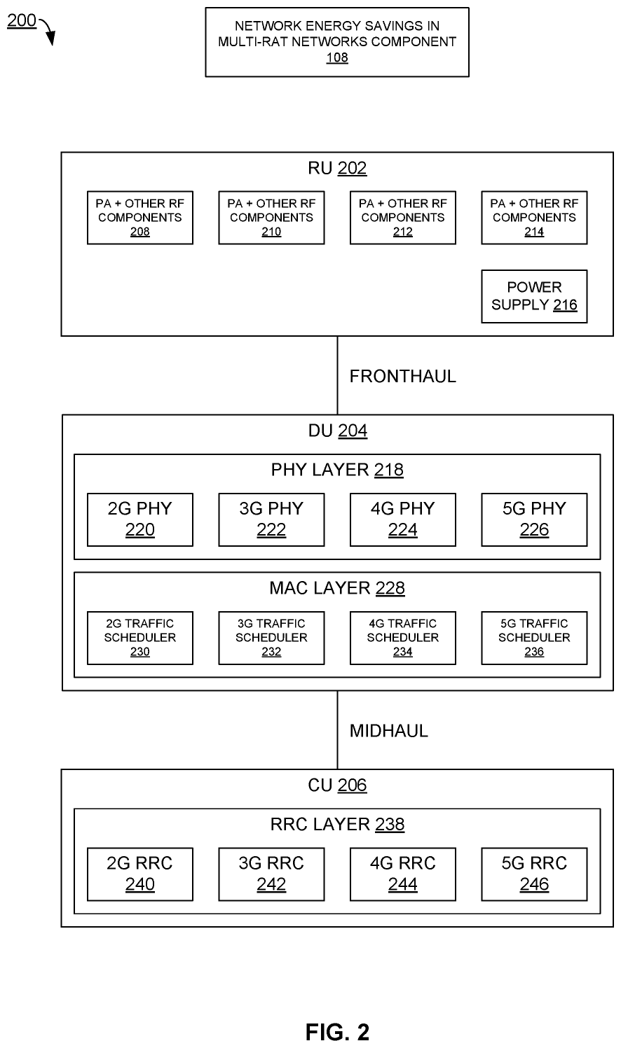

FIG. 2 illustrates an example system architecture 200 for an integrated multi-RAT architecture that considers a colocation based on functionality, and that can facilitate network energy savings in multi-RAT networks, in accordance with an embodiment of this disclosure. In some examples, part(s) of system architecture 200 can be used to implement part(s) of system architecture 100 of FIG. 1.

System architecture 200 comprises radio unit (RU) 202, distributed unit (DU) 204, centralized unit (CU) 206, power amplifier (PA) and other radio frequency (RF) components 208, PA and other RF components 210, PA and other RF components 212, and PA and other RF components 214—each of which may correspond to one of the RATs implemented for the BS. System architecture 200 further comprises power supply 216, physical (PHY) layer 218, second generation (2G) PHY 220, 3G PHY 222, 4G PHY 224, fifth generation (5G) PHY 226, medium access control (MAC) layer 228, 2G traffic scheduler 230, 3G traffic scheduler 232, 4G traffic scheduler 234, 5G traffic scheduler 236, radio resource control (RRC) layer 238, 2G RRC 240, 3G RRC 242, 4G RRC 244, 5G RRC 246, and network energy savings in multi-RAT networks component 248 (which can be similar to network energy savings in multi-RAT networks component 108 of FIG. 1).

As mobile network operators prepare to upgrade their existing networks to 5G NR releases (e.g., Release 17), pre-existing generations of 2G through 4G can still be prevalent. While network energy savings (NES) can be an important goal for all these generations, inherent measures can have been put in place for monitoring and optimization of energy usage in later 3GPP releases that can be largely unavailable in previous generations. Nonetheless, comprehensive measures can be required to ensure a highest possible energy efficiency (or increased energy efficiency) for M-RAT architectures that use an enhanced spectral efficiency of 5G, as well have a wider coverage afforded by previous generations. There can be different approaches to co-locate equipment for M-RATs, and the examples described herein can generally relate to a general case, where each technology uses a different frequency band, and, consequently, a dedicated single or multi-band antenna can be employed for each standard, or alternatively there may be dynamic sharing of spectrum (DSS) between different RATs. While traditional base station design can be more monolithic, later standards can favor a more distributed approach, with an introduction of remote radio heads (RRH), pooled baseband processing units (BBU), and an advent of cloud-RAN (C-RAN). A macro-base station can generally comprise a power supply unit (PSU), a transceiver, and feeder cables for the antenna (in these examples, an antenna can be referred to as a separate entity due to its minimal direct role in energy consumption). Each of these elements can potentially be responsible for a significant amount of energy consumption. The transceiver can manage input and output signals, and it can, in turn, mainly be composed of three sub-elements: a BBU that is configured to perform digital signal processing, a radio frequency (RF) component that is configured to convert digital signals into analog signals and vice versa, and a PA that is configured to amplify the signal for transmission through the antenna. The latter can be reported to be one of the main sources of energy consumption in a base station that can reportedly account for 60% or more of the total energy consumption of the RAN. Each base station can additionally have its backhaul link that connects with a core network.

An energy consumption scenario by a base station can become slightly better when considering multi-RAT architectures that host different technologies at the same time. Operating an M-RAT base station instead of singular monolithic base stations can yield some degree of energy savings as by using several transceivers at once, a single modular PSU can, on average, operate with higher efficiency. Furthermore, C-RANs can comprise architectures where the BBUs are pooled and centralized in a remote location. Centralizing BBUs can eliminate a need to have power-hungry cooling systems in each base station or in each RRH baseband site, which, together with an overall radio site simplification, can reduce OPEX for new sites, as well. C-RAN can also allow for increasing an overall energy efficiency (EE) by sharing computational resources available to signal processing techniques, load balancing among cells, and an implementation of multicell-based techniques.

In some examples, an overall architecture of the access protocol stack can be approximately the same for all cellular technologies. A mobile protocol stack from the lowest to the highest layer can be composed of a physical (L1), a data link (L2), and the network layer (L3). While L1 can largely be composed of an RF component and a series of signal processing components for baseband processing, L2 can be comprised of MAC, radio link control (RLC), and packet data convergence protocol (PDCP). Finally, L3 can handle control concerned with resource management using RRC with control plane (CP) and user plane (UP).

A C-RAN paradigm can provide a functional split between RF and PHY, allowing for maximum remote aggregation. A common public radio interface (CPRI) that is designed to transport sampled radio waveforms to the radio unit can also consume energy that is proportionate to the amount of in-phase quadrature (I/Q) samples that the radio unit uses to transport. Centralizing BBUs can increase their EE, however, a higher fronthaul capacity can generally also mean a higher fronthaul power drain. Transport of I/Q symbols can require a high continuous bitrate. In addition, as the bitrate scales linearly with the number of antennas, it places a higher burden in multiple input multiple output (MIMO) systems. For all these aspects, M-RAT deployments can complicate things further, as signals of multiple RATs can be multiplexed on the fronthaul.

5G can involve an even more careful consideration of the constraints. In 5G NR a CU, a DU, and multiple RUs can be considered to be a central architecture. Consequently, a link between the RU and DU can be referred to as a fronthaul, and a link between the DU and CU can be referred to as a mid-haul. In some examples, a CU can talk to multiple DUs, as well. 5G network deployments can be deployed as per a 3GPP Non-Stand Alone (NSA) architecture, where a NR base station coexists with a LTE base station, and operates under a 4G core. A 3GPP SA architecture, on the other hand, can allow for independent 5G deployments. While both the NSA and SA architectures can be compatible with M-RAT deployments, an NSA version can imply that an LTE radio acts as a master node, and determines the behavior of the associated NR components.

RAN as a Service (RANaaS), whereby an access network is seen more as a service-centric entity can be applicable also to NSA architectures. A RANaaS architecture can also be used to reduce an overall energy consumption while being able to guarantee strict performance guarantees (such as relating to latency). The positions of functional splits can play a role, and an ability to place them dynamically, by actively assigning functionalities among network levels based on current service requirements/traffic demands can give rise to a dynamic network architecture that can be leveraged. A next generation M-RAT implementation with a RU, DU, and CU architecture can facilitate energy savings through maximum function aggregation without committing to a fixed architecture. For example, in some examples baseband functions can be divided between DUs and RUs. Radio items can interact with a virtual BBU, regardless of whether baseband services are provided by a local, middle-tier, or remote unit, or a combination of the three.

Some base stations can need to be always on in order to signal their presence and monitor the radio channel to be visible by UEs. While some power consumption reduction strategies for base stations, such as sleep procedures (or low power consumption states) can be used in prior approaches, they have had limited efficacy far. Upgrading network deployments per newer cellular technology generations can lead to further network densification, as increased throughputs for UEs can usually be attained by progressively improving link budgets by limiting coverage and creating cells with smaller radius. However, this can lead to further randomness in traffic patterns, making the need for effective sleep mechanisms even more acute.

A multi-objective multi-constraint optimization for energy saving in a multi-RAT environment can be as follows. In some examples, one or more of the following can be considerations in such a multi-objective multi-constraint optimization. In a Multi-RAT environment deriving optimal network operational policy considering user association, power control, along with optimal resource allocation, can be a problem. A network cost/utility function prioritizing EE under the constrained resource utilization can be a problem. Moreover, optimal RAT selection in a Multi-RAT scenario comprising 5G NR, LTE, WCDMA, and GPRS RATs through traffic offloading/steering for EE maximization (or savings) can be a problem. Optimally servicing mobile network traffic via directing the request to the appropriate RAT can help with a maximization (or improvement) of an energy efficiency focused network utilization metric. Optimal RAT selection through traffic offloading, in a Multi-RAT network under the constraint of user quality of experience (QoE), therefore, can benefit from a solution.

Regarding these problems, one problem with prior approaches can be a lack of integrated solutions for Multi-RAT EE. While, according to some prior approaches, RAT selection has been considered for wireless devices under various constraints, it can be that there has been little work for optimizing resource selection in a network-centric way for a multi-RAT solution. For the prior approaches that have been made, it can be that the energy efficiency of the base stations has rarely been a criterion, as the emphasis has been on the device side, i.e., the selected RAT is considered to be optimal for usage by the device itself. With a growing concern regarding RAN energy consumption, solutions are needed that solve this problem from a RAN-centric view as well, giving network operators the control over which of the RAT options (available to service the devices) is used at a given time and what resources, computational and otherwise, are allocated to it. Use cases, such as driver assistance through vehicular telematics, mobile health, industrial internet, and the like, can be dependent on wide coverage low power services that are reliable, while high resolution video streaming, real-time content transfer, etc., can require high bandwidth with some error resilience at the application layer. These contrasting requirements can make such decision making even more difficult, and out of bounds for human-level response. An aspect to solve such disparate requirements in an energy-optimal way can be to automate the allocation process, taking into consideration key constraints, and synthesizing a final policy based on a multitude of relevant network data.

Another problem with prior approaches relates to network selection as per EE criteria under multi-RAT constraints. Formulating a network selection problem as an optimization problem with reasonable complexity can be a problem. Obtaining an optimal solution, subject to different networks, applications, and power constraints can lead to a non-deterministic polynomial-time (NP)-hard problem. Moreover, since network resources and channel characteristics can be inherently time-varying, along with the computational resources that can be used to determine their optimal usage, prior optimization approaches can be computationally prohibitive, with an added risk of providing obsolete resource policy recommendations, necessitating a use of online optimization approaches.

The present techniques can be implemented to facilitate an energy consumption optimal reinforcement learning (RL) based framework that is configured to not only choose the network resource that is optimal for the given demand, but also prioritize one that uses a least amount of energy in providing the requisite throughput at an optimal coverage level for the targeted block error rate (BLER).

Note that in the process, in addition to selecting the optimal RAT, the policy recommendation can also optimize scheduling within the selected RAT with a set of dimensions/parameters that pertain only to that RAT. To that end, the present techniques can be implemented to facilitate a framework to resolve the optimal user association problem for various RATs. Additionally, and in contrast to prior approaches, the present techniques can take a network centric view of the problem, rather than a user centric view, to be able to address a base station energy efficiency issue.

Another problem with prior approaches relates to a lack of optimal criteria to shut down RATs per traffic demand.

An aspect of EE Multi-RAT systems can be to shut off parts of the system that are either not in use, or are not a most energy efficient option considering the demand. Determining this can depend on a combination of factors, such as providing continued connectivity, efficient transmission and leveraging channel conditions to use a RAT (such as a best possible RAT) to address the traffic request. For example, while 2G and 4G system can require more of always ON approach to provide connectivity, control signaling overhead can be relatively higher compared to 5G NR. On the other hand, from a coverage standpoint, 2G systems can provide wider coverage, and, if using a different narrow frequency band, can provide baseline connectivity for a wide set of users by acting as an underlay system with the ability to handle packetized transmission at a very low bit rate.

In general, switching RAT(s) on/off too frequently can be impractical, since the switching process itself can take time, and can require additional compute resources, as well as protocol overhead. Therefore, an approach can be to do the active RAT selection on a large timescale, e.g., based on an average daily traffic load profile obtained from long-term observations. This approach can be optimized, or improved, through offline training. Nonetheless, with a dynamic nature of future applications there can be deviation from assumptions under which training is performed to an actual operational environment. For example, when the average traffic load is high, it can be that more active RATs (some operating in parallel) are selected, while when the average traffic becomes relatively low, a few RATs can be switched off, which can make sense from an EE enhancement perspective. A number of candidate RATs in practical systems can usually be small, and therefore such a combination of offline learning, which can lead to a look-up table for selecting optimal active RATs, and online learning that avoids an exhaustive search, can be made computationally cheap.

The present techniques can be implemented as follows, such as to optimize operations of a base station under a multi-RAT configuration, which can focus on energy efficiency while also additionally ensuring optimal resource allocation, optimal RAT selection, and a simplification of network control through a unified view.

A high-level functional diagram embedding the inventive aspects of the current disclosure is shown in FIG. 2. In particular, when a UE service request is received, a CU/DU server can host what can be referred to as a service request staging and preprocessing component. This component can be configured to use a reported reference signal received power (RSRP), or received signal strength indicator (RSSI), for the relevant RATs that it can connect to for pre-processing purposes, with a first level of filtering performed by discarding the RATs that do not meet the required threshold for coverage. For UEs that are already connected but have a new service request (in examples where one UE is capable of running several applications simultaneously, one of which can require a new request to connect to the base station), signal-to-interference and noise ratio (SINR) can also be used for the preprocessing. For the RATs that meet the threshold, these metrics (data points) can be fed into the AI/ML engine for RAT selection component for decision making on an optimal RAT to schedule the UE on. The AI/ML policy engine can further be supported by the energy efficiency computation component that is configured to compute the energy efficiency on a per RAT basis, and is described further herein.

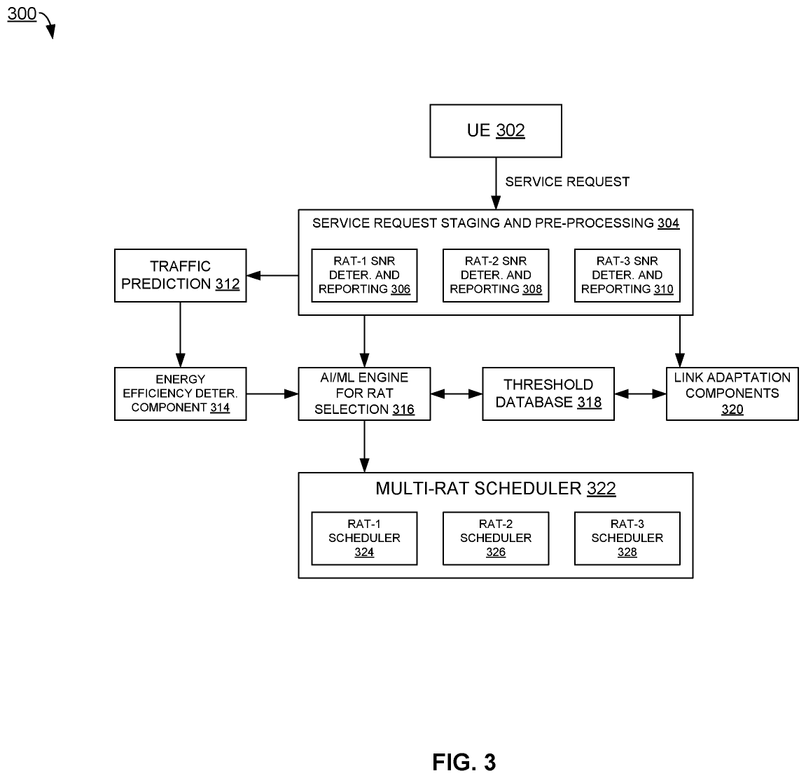

FIG. 3 illustrates an example system architecture 300 for AI/ML-based RAT selection based on energy efficiency, and that can facilitate network energy savings in multi-RAT networks, in accordance with an embodiment of this disclosure. In some examples, part(s) of system architecture 300 can be used to implement part(s) of system architecture 100 of FIG. 1.

System architecture 300 comprises UE 302, service request staging and pre-processing 304, RAT-1 signal-to-noise ratio (SNR) determination and reporting 306, RAT-2 SNR determination and reporting 308, RAT-3 SNR determination and reporting 310, traffic prediction 312, energy efficiency determination component 314, AI/ML engine for RAT selection 316, threshold database 318, link adaptation components 320, multi-RAT scheduler 322, RAT-1 scheduler 324, RAT-2 scheduler 326, and RAT-3 scheduler 328.

Additionally, the AI/ML policy engine can also access a database that maintains a set of transmission thresholds—e.g. minimum RSRP/RSSI levels for each of the RATs for the selection and use of a certain target spectral efficiency (through a combination of modulation and coding schemes/rates)—that can be used to determine whether a given UE can be scheduled on a given RAT for the requested throughput. These thresholds can be dynamic due to a time-varying nature of the channel, and can therefore be updated periodically based on information received from the link adaptation components corresponding to each RAT. The AI/ML policy engine can work in tandem with other components that can provide the requisite telemetry or execute ML based prediction algorithms themselves to characterize a future state of the network.

In some examples, there is little to no interference between RATs, since different RATs operate in different frequency bands. Given a network-centric approach, in some examples, the CU can host a central control component that is configured to perform radio resource management (RRM) for multi-carrier transmission, and can facilitate parallel transmission among RATs to split the servicing of a demand. For parallel transmission, a desired data stream can be split into multiple sub-streams for multiple RATs to transmit simultaneously. In some examples, this can be more likely to happen between RATs that share a common air interface such as 4G and 5G based RATs in SA or NSA mode as both use orthogonal frequency-division multiple access (OFDMA), and in some examples, have common channel bandwidths and sub-carrier spacing, as well.

The present techniques can be implemented to facilitate energy efficiency optimal user association for Multi-RAT. An optimization according to the present techniques can be an overall energy efficiency optimization when UEs are serviced in a multi-RAT scenario. RAT selection can consider a UE-centric utility function that can maximize a QoS of the UE, and can lead a user association for a greatest benefit of the UE. However, in some examples, this can be counterproductive in two ways: (1) It can be that it does not always lead to a solution that reduces the network energy consumption, and (2) It can also lead to a highly unbalanced network that allows the greedy approach of UEs to determine the network operational state.

The present techniques can be implemented to facilitate a maximization of a utility function with network energy consumption at its core. A single agent RL environment can be implemented, where the agent tries to learn an optimal policy from interactions with the environment, aiming to maximize its reward. This can be possible due to a network-centric RAT selection approach that can be implemented according to the present techniques. Conversely, if the UEs were to make the decision of RAT selection, then it could be that a multi-agent reinforcement learning environment would be considered, which can lead to an action and state space that is more complicated, and it can be that fully distributed approaches do not guarantee convergence to equilibrium states, in addition to being slow, and requiring high exploration times. An objective function can be implemented that is optimized through reinforcement learning. The state space can be comprised of:

The set of RATs, denoted by N_{RAT}

The power consumption of each of the RATs: P_{RAT}^{k} for the k^{th} RAT

The channel resources of the k^{th} RAT (for, e.g., a number of subcarriers with a given MCS for an OFDMA-based system, C^{k} is subject to a maximum resource limit C_{MAX}^{k}).

With overall energy efficiency being defined as:

$$ε = {\sum }_{k = 1}^{{N}_{RAT}} {\sum }_{j = 1}^{{C}_{MAX}^{k}} {I}_{k , j} * {P}_{RAT}^{k} * {C}_{j}^{k} - + {\sum }_{k = 0}^{{N}_{RAT}} {A}_{k} * {P}_{k}^{0}$$

$$Where$$

$$\text{?} {I}_{k , j} = \{ \begin{matrix}1 , & if the {k}^{th} RAT and its {j}^{th} channel are in use \\ 0 , & otherwise\end{matrix}$$

$$and$$

$${A}_{k} = \{ \begin{matrix}1 , & if the {k}^{th} RAT is powered on , \\ 0 , & otherwise\end{matrix}$$

$$\text{?} \text{indicates text missing or illegible when filed}$$

can be indicator functions and Pₖ⁰ denotes energy consumed by the k^{th} RAT in idle mode, that is, no traffic mode being carried. Selection can be subject to the following further constraints:
Constraint C₀: Σᵤγ_{j,k}≤Cₖ^{MAX}; ∀u (which can ensure that resources assigned to users cannot exceed maximum resources available for all UEs denoted by u)
Constraint C₁: Qₘᵢₙ(u)≤Q^{n∈N}^{_{RAT}} (u)≤Qₘₐₓ(u): can guarantee a desired KPI level (Q) for user u, connect to the RATn∈N_{RAT}, in the network is satisfied with KPI tolerance bounds Qₘᵢₙ(u) and Qₘₐₓ(u). In some examples, KPI can be delay, throughput, or another parameter that is selected by a service provider per SLA.

The present techniques can also be implemented to facilitate a RL framework for optimal RAT selection. Large portions of an IoT traffic, such as machine to machine (M2M) and vehicular telematics, can use 2G processing. 5G rollout can continue to be following a phased approach in different markets with an NSA mode being a primary approach, whereby the protocol processing control is performed with a 4G core, and 5G access features are supported on top of the core. For such multi-RAT deployments to be economically viable, it can be that a network equipment provider (NEP) supports approaches to deal with complexities of supporting multiple RATs with minimized energy usage.

Moreover, since network resources and characteristics can vary with time, as well as the edge resources, it can be that prior optimization approaches can be computationally expensive, and online optimization approaches, such RL, can be implemented. With RL environments, deep q-networks (DQN) (policy or value based) can be implemented for optimization, and the state space, action and rewards can be defined accordingly. According to the present techniques, they can be mapped as follows.

The state space can comprise a set of RATs (N_{RAT}) and the available resource for the RAT(Cₖ^{MAX}). There can be an energy efficiency associated with the use of the resource within that RAT that can be derived from the energy efficiency compute model. This can take into account predicted traffic for that time interval for each RAT, and the use of a variable bias on the shared PA.

The action space can be nested in the sense that can take into account both the selection of a given RAT, and allocated resources within that RAT. This can be, for example, the set of sub-carriers that allow for the highest spectral efficiency while maintaining the target BLER for that RAT. Furthermore, for an operational network, the RL agent can continually evaluate the possibility of transferring a UE to the most energy optimal RAT while in connected state. This can occur, for example, in the case where a 5G NR connected UE is transferred to a 3G RAT to create more DTX opportunities for the 5G RAT.

Reward shaping can be implemented as follows. The RL agent can receive a positive reward if the energy consumption of the multi-RAT base station achieves a value lower than a threshold ε_{MA}^{θ}, and a negative reward if the energy efficiency goes up compared to the time. Here ε_{MA}^{θ} can comprise the time averaged energy efficiency for a particular load θ.

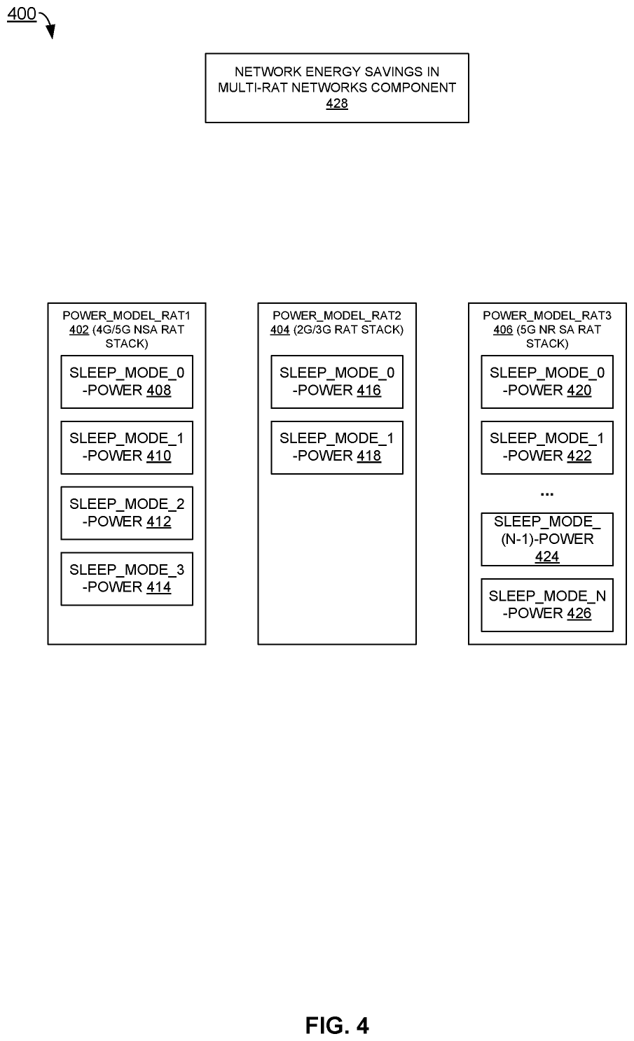

FIG. 4 illustrates an example power consumption modeling for a multi-RAT architecture with a shared PA, and that can facilitate network energy savings in multi-RAT networks, in accordance with an embodiment of this disclosure. In some examples, part(s) of power consumption modeling 400 can be used to implement part(s) of system architecture 100 of FIG. 1.

System architecture 400 comprises power_model_RAT1 402 (4G/5G NSA RAT stack), power_model_RAT2 404 (2G/3G RAT stack), power_model_RAT3 406 (5G NR SA RAT stack) with various sleep modes that have corresponding power consumptions denoted bysleep_mode_0-power 408, sleep_mode_1-power 410, sleep_mode_2-power 412, sleep_mode_3-power 414, sleep_mode_0-power 416, sleep_mode_1-power 418, sleep_mode_0-power 420, sleep_mode_1-power 422, sleep_mode_(N−1)-power 424, sleep_mode_N-power 426, and network energy savings in multi-RAT networks component 428 (which can be similar to network energy savings in multi-RAT networks component 108 of FIG. 1).

The present techniques can be implemented to facilitate energy efficient computation with a shared PA approach. In addition to the RAT selection, there can be use of components in FIG. 3. One of these components is the ML-based traffic predictor that can internally use a long-short term memory (LSTM) based architecture on a per RAT basis to predict traffic that each RAT can be servicing over time. This can be distinct from a single-RAT based predictor where all traffic is governed by the resources available for that RAT. A multi-RAT base station can take into account the traffic that is serviced on an individual RAT basis. Furthermore, the energy efficiency compute component can house power consumption models for individual RATs that take into account the ability or lack thereof in each of the models to operate in a lower power consumption state, as shown in FIG. 3.

In this example, there are three different power models as, denoted by RAT1, RAT2, and RAT3 whereby each has a different low power consumption state that it can use, and a variation exists both in the power usage in that state and the total number of such possible states. For example, RAT2 can model a 2G or 3G RAT whereby two sleep modes are available, of which one where it is completely switched off (and thus provides no connectivity), and second is where control-plane traffic is flowing to maintain coverage and no data is being directed to due to the high bandwidth requirements of the requesting UEs.

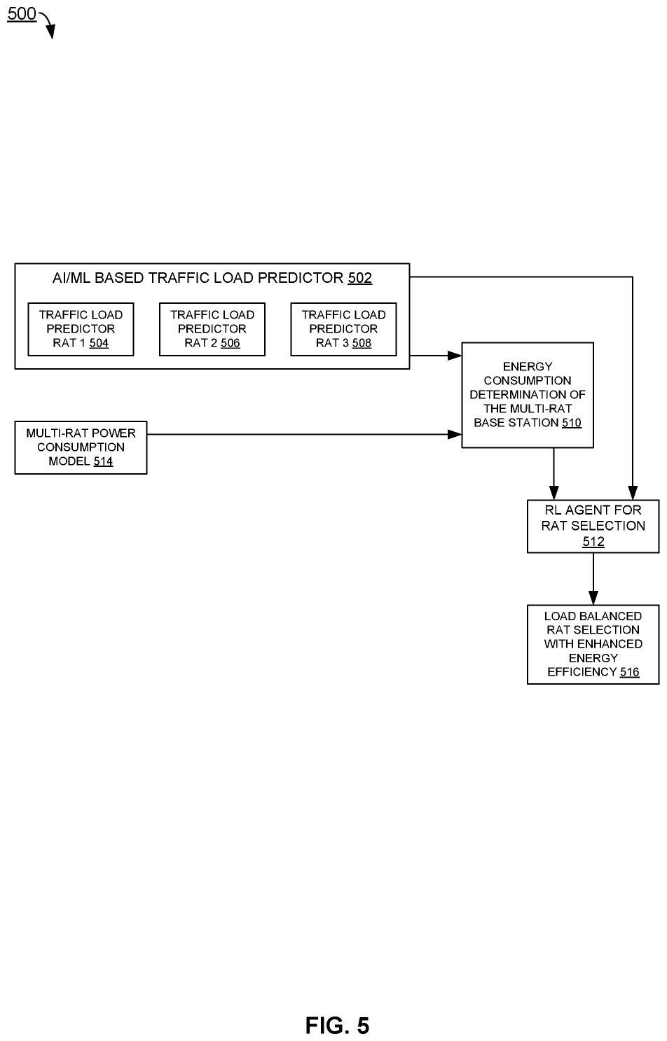

FIG. 5 illustrates an example system architecture 500 for a load-balanced multi-RAT base station selection with energy efficiency, and that can facilitate network energy savings in multi-RAT networks, in accordance with an embodiment of this disclosure. In some examples, part(s) of system architecture 500 can be used to implement part(s) of system architecture 100 of FIG. 1.

System architecture 500 comprises AI/ML based traffic load predictor 502, which in turn comprises of traffic load predictor RAT 1 504, traffic load predictor RAT 2 506, traffic load predictor RAT 3 508 for individual RATs, energy consumption determination of the multi-RAT base station 510, RL agent for RAT selection 512, multi-RAT power consumption model 514 (which can be similar to system architecture 400 of FIG. 4), and load balanced RAT selection with enhanced energy efficiency 516.

The following are examples of how the present techniques can help in mitigation of various aspects related to energy efficiency and resource allocation in contemporary multi-RAT networks.

One example of how the present techniques can help in mitigation of various aspects related to energy efficiency and resource allocation in contemporary multi-RAT networks can relate to load balancing. For sites with multiple RATs but separate PAs per RAT, load balancing between the RATs can be an alternative. Where 4G and 5G NR can reduce energy consumption by use of sleep modes, one approach can be to enhance an overall energy performance by transferring as much traffic as possible to a 3G RAT, for example. This can allow the 5G NR SA, 5G NR-NSA to be put in deeper hardware sleep states, followed by the 4G-LTE RAT, where most of the traffic is non-packet or short-packet bursty. For 3G/HSPA the traffic can potentially increase to accommodate all the 5G NR and LTE traffic, so balance can be maintained. Furthermore, this can enhance the opportunities for cell DTX, reducing the power consumption in accordance with hardware improvements as described herein.

It can be seen in a deployment with several multi-RAT base stations that, if the traffic is always steered to the same base station with a certain RAT that can best satisfy the desired QoS, it can potentially devolve into an unbalanced load distribution. This can eventually degrade important network KPIs such as delay, packet drops, etc., and thus have an overall negative impact on the system throughput. However, in a RL environment according to the present techniques, the base station can be empowered either themselves to make these decisions (considering base station load conditions explicitly), or it can be enforced through a RIC that is configured to predict a load on multiple base stations based on both the current load conditions as well as an aggregated version of the traffic prediction component shown in FIG. 2. Without such configuration according to the present techniques, other than network performance degradation, the network can even exhibit potential oscillation and instability.

Moreover, in examples where this decision making is left to the UEs to be carried out in a distributed fashion, then it can be that most existing distributed RAT selection approaches require that all users know the historical selection policy/decisions of other users. The knowledge of the instantaneous rates of the other users can come at a cost of substantially increased complexity, signaling, and communication load. Conversely, when the problem is addressed within a single agent reinforcement learning approach, it can be that most of the communication is internal to the base station, and the RL agent is able to assimilate several network measurements and synthesize an intelligent policy that can significantly minimize the signaling overhead.

In contrast to a conventional traffic steering problem where load balancing is done to direct the traffic to the correct base station, in some examples, the present techniques can be implemented to facilitate directing traffic to the correct RAT considering two constraints:

Balanced load distribution amongst different RATs based on the traffic demand; and

Re-direct demand to the RAT that minimizes a global energy consumption.

An example capable of achieving this is shown in FIG. 4. The main energy efficiency compute block can derive its inputs from two blocks: (a) the ML-based traffic predictor and the (b) Multi-RAT power computation. In a multi-RAT base station, a traffic predictor can base its prediction on a percentage of total traffic that has been redirected to each base station. In this example, there can be a dedicated traffic predictor for each RAT. A history of traffic states of each predictor can also be influenced by how previous states can represent a result of a RAT selection that was also influenced by energy efficiency considerations. This can be highlighted when considering that the RL agent for RAT selection in FIG. 4 can derive its inputs from both the energy consumption metrics on a per RAT basis for the predicted traffic, as well as the load experience by each RAT if the traffic were to be directed to it. Therefore, the RL agent can be able to respond with a policy that can explicitly take into account the dynamic operational environment of the multi-RAT base station.

Another example of the present techniques can relate to resource allocation for energy efficiency maximization in multi-rate transmission. In some examples, approaches according to the present techniques can be used to further optimize the energy efficiency within the RAT. For example, even when allocating resources between two OFDMA based RATs, it can be possible that due to the operational requirements and current load on a given RAT, one RAT is more optimal than the other from the perspective of a given network metric such as throughput, energy efficiency maximization, or overall load balancing. This can occur due to both the time varying nature of the traffic itself, and the variation in channel conditions over different frequency regions that each RAT operates in. A benefit of the present techniques that can be had by enabling an RL agent to handle the activation of particular energy saving features can be that, when servicing a UE request, the resource request can be split across RATs. This can lead to an expanded resource scheduling sub-space for the RL agent, whereby a more energy optimal operating point can be found by allowing for parallel transmission on two RATs simultaneously in order to meet a desired QoS of the UE. This can help in two ways: (a) more UEs can be admitted and serviced thereby increasing the achieved throughput of the network, and (b) soft migration of UEs to a single RAT if the energy optimization policy recommends switching off a RAT completely, such the degradation in QoS is gradual.

### Example Process Flows

FIG. 6 illustrates an example process flow 600 that can facilitate network energy savings in multi-RAT networks in base stations, in accordance with an embodiment of this disclosure. In some examples, one or more embodiments of process flow 600 can be implemented by network energy savings in multi-RAT networks component 108 of FIG. 1, or wireless communications operating environment 1000 of FIG. 10.

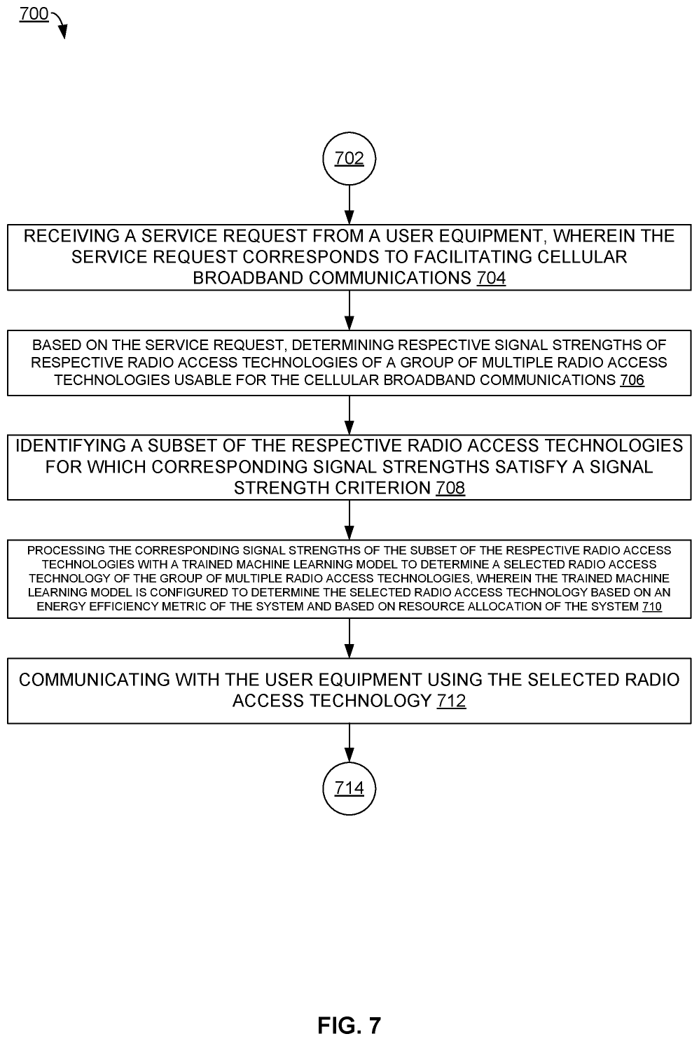

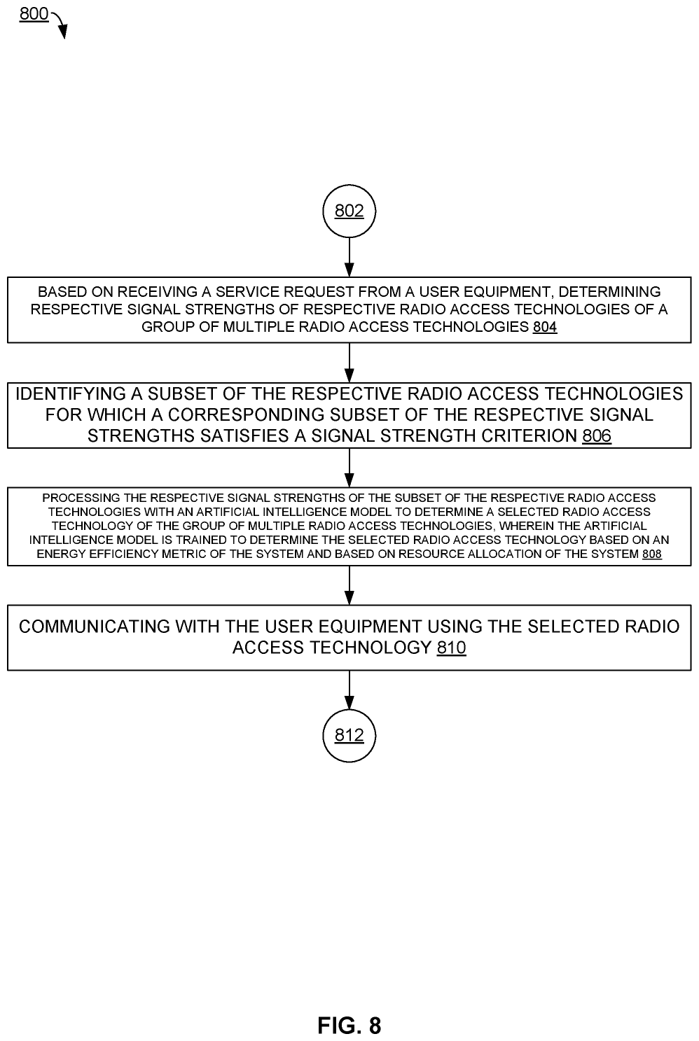

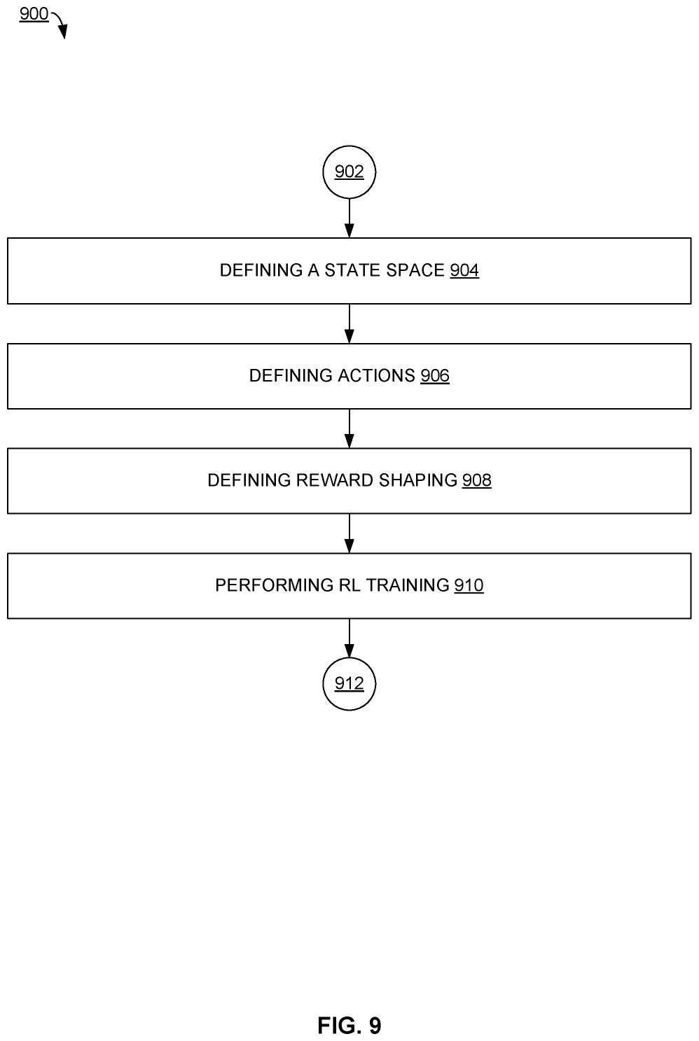

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 700 of FIG. 7, process flow 800 of FIG. 8, and/or process flow 900 of FIG. 9.

Process flow 600 begins with 602, and moves to operation 604.

Operation 604 depicts receiving a service request from a user equipment. Using the example of FIG. 1, user equipment 104 can make a service request to base station 102.

After operation 604, process flow 600 moves to operation 606.

Operation 606 depicts, based on the service request, determining respective signal strengths of respective radio access technologies of multiple radio access technologies being used for cellular broadband communications. That is, a base station (e.g., base station 102 of FIG. 1) can be a multi-RAT base station.

After operation 606, process flow 600 moves to operation 608.

Operation 608 depicts identifying a subset of the respective radio access technologies for which a signal strength criterion is satisfied. That is, initially in selecting a RAT for the user equipment, possible RATs can be filtered, such as based on having a sufficient RSRP or RSSI that the user equipment can connect to for pre-processing purposes. RATs that do not meet a threshold for coverage can be discarded from consideration.

In some examples, at least one of the respective signal strengths comprises a reference signal received power value. In some examples, at least one of the respective signal strengths comprises a received signal strength indicator value.

In some examples, when receiving the service request from the user equipment occurs, at least some of the cellular broadband communications are being conducted with the user equipment for usage of a first application of the user equipment, wherein the service request corresponds to a second application of the user equipment, and wherein at least one of the respective signal strengths comprises a signal-to-interference and noise ratio value. That is, for UEs that are already connected but have a new service request (where a UE is capable of running several applications simultaneously, one of which provides a new request to connect to a base station), SINR can be used in operation 608 as the signal strength metric.

After operation 608, process flow 600 moves to operation 610.

Operation 610 depicts processing a subset of the respective signal strengths corresponding to the subset of the respective radio access technologies using a machine learning model to determine a selected radio access technology of the multiple radio access technologies, wherein the machine learning model is trained to determine the selected radio access technology based on an energy efficiency metric of the system and based on resource allocation of the system. That is, for the RATs that meet the threshold of operation 608, these metrics can be provided as input to a machine learning model for decision-making on a RAT to schedule the UE on.

In some examples, this can involve using overall energy efficiency of multi-RAT base station as an element of RAT selection. In some examples, the selection of the RAT can also be subject to QoS constraints.

In some examples, the machine learning model is trained to favor increasing the energy efficiency metric of the system while satisfying the resource allocation of the system. That is, the machine learning model can be configured to focus on energy efficiency while also ensuring optimal resource allocation, or resource allocation that satisfies a criterion related to resource allocation.

In some examples, the machine learning model is trained to determine the selected radio access technology based on a service level agreement that corresponds to a performance metric applicable to the cellular broadband communications. That is, the machine learning model can be trained to determine on which mode to operate each RAT when servicing a certain set of requests so as to not violate SLAs, using a network-centric approach.

In some examples, the machine learning model is trained to determine the selected radio access technology based on satisfying at least one of a requested quality-of-service metric associated with the user equipment, a data rate associated with the user equipment, or a contract associated with the user equipment. That is, the machine learning model can be trained to determine an optimal association of UEs with the base station/RAT based on certain criteria (e.g., requested QoS, data rate or other performance contracts) for efficient utilization of the available radio resources with an energy efficiency optimization constraint.

After operation 610, process flow 600 moves to operation 612.

Operation 612 depicts communicating with the user equipment via the selected radio access technology. That is, the base station can schedule the UE on the RAT determined in operation 610.

In some examples, the cellular broadband communications are first cellular broadband communications, and operation 612 comprises updating the offline trained machine learning model according to online reinforcement learning based on feedback resulting from in-field operations of conducting second broadband cellular communications. That is, online learning can be implemented on the pre-trained machine learning model to incorporate feedback received from in-field operations to update the model to improve an objective of energy savings.

After operation 612, process flow 600 moves to 614, where process flow 600 ends.

FIG. 7 illustrates an example process flow 700 that can facilitate network energy savings in multi-RAT networks in base stations, in accordance with an embodiment of this disclosure. In some examples, one or more embodiments of process flow 700 can be implemented by network energy savings in multi-RAT networks component 108 of FIG. 1, or wireless communications operating environment 1000 of FIG. 10.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 600 of FIG. 6, process flow 800 of FIG. 8, and/or process flow 900 of FIG. 9.

Process flow 700 begins with 702, and moves to operation 704.

Operation 704 depicts receiving a service request from a user equipment, wherein the service request corresponds to facilitating cellular broadband communications. In some examples, operation 704 can be implemented in a similar manner as operation 604 of FIG. 6.

After operation 704, process flow 700 moves to operation 706.

Operation 706 depicts, based on the service request, determining respective signal strengths of respective radio access technologies of a group of multiple radio access technologies usable for the cellular broadband communications. In some examples, operation 706 can be implemented in a similar manner as operation 606 of FIG. 6.

After operation 706, process flow 700 moves to operation 708.

Operation 708 depicts identifying a subset of the respective radio access technologies for which corresponding signal strengths satisfy a signal strength criterion. In some examples, operation 708 can be implemented in a similar manner as operation 608 of FIG. 6.

After operation 708, process flow 700 moves to operation 710.

Operation 710 depicts processing the corresponding signal strengths of the subset of the respective radio access technologies with a trained machine learning model to determine a selected radio access technology of the group of multiple radio access technologies, wherein the trained machine learning model is configured to determine the selected radio access technology based on an energy efficiency metric of the system and based on resource allocation of the system. In some examples, operation 710 can be implemented in a similar manner as operation 610 of FIG. 6.

In some examples, the trained machine learning model is a pre-trained machine learning model, and operation 710 comprises training a machine learning model to produce the pre-trained machine learning model according to a single-agent reinforcement learning process, wherein a state space of the single-agent RL process comprises the group of multiple radio access technologies, respective power consumption values of respective multiple radio access technologies of the group of multiple radio access technologies, and respective channel resources of the respective multiple radio access technologies. That is, single-agent RL can be implemented, where the agent attempts to learn an optimal policy from interactions with its environment, aiming to maximize its reward. A state space for the RL process can comprise the set of RATs, denoted by N_{RAT}; the power consumption of each of the RATs (P_{RAT}^{k} for the k^{th} RAT); and the channel resources of the k^{th} RAT (for, e.g., a number of subcarriers with a given MCS for an OFDMA-based system, C^{k} is subject to a maximum resource limit C_{MAX}^{k}).

In some examples, operation 710 comprises maintaining a data store that comprises respective transmission thresholds for the respective radio access technologies, and respective target spectral efficiencies of the respective radio access technologies, and determining the selected radio access technology of the group of multiple radio access technologies is based on determining that the selected radio access technology is configured to schedule the user equipment to use the selected radio access technology to achieve a requested throughput. In some examples, operation 710 comprises, in response to an update criterion being determined to be satisfied, updating the respective transmission thresholds for the respective radio access technologies based on information received from respective link adaptation components of the respective radio access technologies. That is, the machine learning model can have access to a database that maintains a transmission thresholds (e.g., minimum RSRP/RSSI levels for each of the RATs for the selection and use of a certain target spectral efficiency (through a combination of modulation and coding schemes/rates)) that can be used to determine if a given UE can be scheduled on a given RAT for the requested throughput. These thresholds can be dynamic due to a time-varying nature of the channel, and so can be updated periodically based on information received from the link adaptation modules corresponding to each RAT.

In some example, operation 710 comprises training a machine learning model to produce the trained machine learning model according to a reinforcement learning process, wherein the reinforcement learning process is configured to receive a positive reward when an energy consumption associated with a state of the reinforcement learning process is less than an average energy efficiency for a load, and wherein the reinforcement learning process is configured to receive a negative reward when the energy consumption associated with the state of the reinforcement learning process is greater than the average energy efficiency for the load. That is, reward shaping can be used with a RL agent, where the RL agent receives a positive reward if the energy consumption of the multi-RAT BS achieves a value lower than a threshold ε_{MA}^{θ}, and a negative reward if the energy efficiency goes up compared to the time. Here ε_{MA}^{θ} can comprise the time averaged energy efficiency for a particular load θ.

After operation 710, process flow 700 moves to operation 712.

Operation 712 depicts communicating with the user equipment using the selected radio access technology. In some examples, operation 712 can be implemented in a similar manner as operation 612 of FIG. 6.

In some examples, the selected radio access technology is a first selected radio access technology. In such examples, operation 712 can comprise, after determining the selected radio access technology of the group of multiple radio access technologies, determining, by the system and with the trained machine learning model, a second selected radio access technology of the group of multiple radio access technologies, wherein the second selected radio access technology corresponds to a better energy efficiency criterion with respect to the user equipment than the first selected radio access technology, and transferring the user equipment from the first selected radio access technology to the second selected radio access technology. That is, for an operational network, an RL agent can continually evaluate a possibility of transferring a UE to a most energy optimal RAT while in a connected state. This can occur, for example, in a case where a 5G NR connected UE is transferred to a 3G RAT to create more DTX opportunities for the 5G RAT.

After operation 712, process flow 700 moves to 714, where process flow 700 ends.

FIG. 8 illustrates an example process flow 800 that can facilitate network energy savings in multi-RAT networks in base stations, in accordance with an embodiment of this disclosure. In some examples, one or more embodiments of process flow 800 can be implemented by network energy savings in multi-RAT networks component 108 of FIG. 1, or wireless communications operating environment 1000 of FIG. 10.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 600 of FIG. 6, process flow 700 of FIG. 7, and/or process flow 900 of FIG. 9.

Process flow 800 begins with 802, and moves to operation 804.

Operation 804 depicts, based on receiving a service request from a user equipment, determining respective signal strengths of respective radio access technologies of a group of multiple radio access technologies. In some examples, operation 804 can be implemented in a similar manner as operations 604-606 of FIG. 6.

After operation 804, process flow 800 moves to operation 806.

Operation 806 depicts identifying a subset of the respective radio access technologies for which a corresponding subset of the respective signal strengths satisfies a signal strength criterion. In some examples, operation 806 can be implemented in a similar manner as operation 608 of FIG. 6.

After operation 806, process flow 800 moves to operation 808.

Operation 808 depicts processing the respective signal strengths of the subset of the respective radio access technologies with an artificial intelligence model to determine a selected radio access technology of the group of multiple radio access technologies, wherein the artificial intelligence model is trained to determine the selected radio access technology based on an energy efficiency metric of the system and based on resource allocation of the system. In some examples, operation 808 can be implemented in a similar manner to operation 610 of FIG. 6.

In some examples, the artificial intelligence model comprises a group of long-short term memory models, and wherein respective long-short term memory models of the group of long-short term memory models correspond to the respective radio access technologies. That is, the artificial intelligence model can comprise an ML-based traffic predictor that uses a LSTM-based architecture on a per RAT basis to predict the traffic that each RAT may be servicing over time.

In some examples, operation 808 comprises storing respective power consumption models for the respective radio access technologies, wherein the respective power consumption models comprise respective amounts of power consumed in respective low-power states, in addition to the nominal power consumption when no low-power states are activated for respective RAT.

In some examples, operation 808 comprises storing respective power consumption models for the respective radio access technologies, wherein at least two power consumption models of the respective power consumption models differ in terms of a number of power consumption states.

That is, in determining a RAT, different power models for different RATs can be considered, where there can be a variation in both a power usage in a given state and a total number of such possible states.

In some examples, the respective radio access technologies correspond to use of respective power amplifiers that have different energy consumption, and the artificial intelligence model is configured to perform load balancing amongst the different radio access technologies that comprise the user equipment. That is, in sites with multiple RATs but separate PAs per RAT, load balancing between the RATs can be performed.

In some examples, a first base station is configured to provide the group of multiple radio access technologies, and a radio access network intelligent controller is configured to perform load balancing among respective base stations of a group of base stations that comprises the first base station based on current load conditions and a traffic prediction model. That is, a RIC can predict a load on multiple base stations and load balance across the base stations.

After operation 808, process flow 800 moves to operation 810.

Operation 810 depicts communicating with the user equipment using the selected radio access technology. In some examples, operation 810 can be implemented in a similar manner as operation 612 of FIG. 6.

After operation 810, process flow 800 moves to 812, where process flow 800 ends.

FIG. 9 illustrates an example process flow 900 for training a model with a reinforcement learning agent, and that can facilitate network energy savings in multi-RAT networks in base stations, in accordance with an embodiment of this disclosure. In some examples, one or more embodiments of process flow 900 can be implemented by network energy savings in multi-RAT networks component 108 of FIG. 1, or wireless communications operating environment 1000 of FIG. 10.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 600 of FIG. 6, process flow 700 of FIG. 7, and/or process flow 800 of FIG. 8.

Process flow 900 begins with 902, and moves to operation 904.

Operation 904 depicts defining a state space. In some examples, the state space can comprise a set of RATs (N_{RAT}) and the available resource for the RAT(Cₖ^{MAX}). There can be an energy efficiency associated with the use of the resource within that RAT that can be derived from the energy efficiency compute model. This can take into account predicted traffic for that time interval for each RAT, and the use of a variable bias on the shared PA.

After operation 904, process flow 900 moves to operation 906.

Operation 906 depicts defining actions. In some examples, an action space can be nested in the sense that can take into account both the selection of a given RAT, and the resources to be allocated within that RAT. This can be, for example, the set of sub-carriers that allow for the highest spectral efficiency while maintaining the target BLER for that RAT. Furthermore, for an operational network, the RL agent can continually evaluate the possibility of transferring a UE to the most energy optimal RAT while in connected state. This can occur, for example, in the case where a 5G NR connected UE is transferred to a 3G RAT to create more DTX opportunities for the 5G RAT.

After operation 906, process flow 900 moves to operation 908.

Operation 908 depicts defining reward shaping. In some examples, reward shaping can be implemented as follows. The RL agent can receive a positive reward if the energy consumption of the multi-RAT base station achieves a value lower than a threshold ε_{MA}^{θ}, and a negative reward if the energy efficiency goes up compared to the time. Here ε_{MA}^{θ} can comprise the time averaged energy efficiency for a particular load θ.

After operation 908, process flow 900 moves to operation 910.

Operation 910 depicts performing RL training. This can comprise performing RL training on a ML model using the state space of operation 904, the action space of operation 906, and the reward shaping of operation 908. The trained ML model can be used to select a RAT in a multi-RAT scenario, as described herein.

After operation 910, process flow 900 moves to 912, where process flow 900 ends.

### Example Operating Environment

In order to provide additional context for various embodiments described herein, FIG. 10 and the following discussion are intended to provide a brief, general description of a suitable wireless communications operating environment in which the various embodiments of the embodiment described herein can be implemented.

For example, parts of wireless communications operating environment can be used to implement one or more embodiments of base station 102 and/or user equipment 104 of FIG. 1.

In some examples, wireless communications operating environment can implement one or more embodiments of the process flows of FIGS. 6-9 to facilitate network energy savings in multi-RAT networks in base stations.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

FIG. 10 illustrates an example block diagram of a wireless communications operating environment 1000 operable to execute an embodiment of this disclosure. A UE of UE(s) 1004A, UE(s) 1004B, and/or UE(s) 1004N can generally comprise a device used by an end user to access a communications network. A UE can be configured to receive messages from communications network 1006, which can be, for instance, a global communications network such as the Internet.

Messages sent from A UE can be received and processed by core network 1008, which can comprise components of a 3G, 4G, LTE, 5G, or other, wireless communication network. Core network 1008 can be configured to establish connectivity between a UE and communications network 1006, such as through facilitating services such as connectivity and mobility management, authentication and authorization, subscriber data management, and policy management. Messages sent between a UE and communications network 1006 can propagate through CU 1010, DU 1012, RU 1014, and antenna 1016A, antenna 1016B, or antenna 1016N.

CU 1010 can be configured to process non-real-time RRC and PDCP communications. DU 1012 can be configured to process communications transmitted according to RLC, MAC, and PHY layers. RU 1014 can be configured to convert radio signals sent to antenna 1016 from digital packets to radio signals, and convert radio signals received from antenna 1016 from radio signals to digital packets.

Antenna 1016A, antenna 1016B, and antenna 1016N (which can comprise a transceiver) can each be configured to send and receive radio waves that are used to convey information. Antenna 1016A can facilitate LTE communications; antenna 1016B can facilitate 5G communications; and antenna 1016N can facilitate 4G communications. The use of these multiple radio-access technologies to facilitate communications can comprise a multi-RAT environment.

### CONCLUSION

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, optical disk storage, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method, comprising:
receiving, by a system, a service request from a user equipment;
based on the service request, determining, by the system, respective signal strengths of respective radio access technologies of multiple radio access technologies being used for cellular broadband communications;
identifying, by the system, a subset of the respective radio access technologies for which a signal strength criterion is satisfied;
processing, by the system, a subset of the respective signal strengths corresponding to the subset of the respective radio access technologies using a machine learning model to determine a selected radio access technology of the multiple radio access technologies, wherein the machine learning model is trained to determine the selected radio access technology based on an energy efficiency metric of the system and based on resource allocation of the system; and
communicating, by the system, with the user equipment via the selected radio access technology.

2. The method of claim 1, wherein at least one of the respective signal strengths comprises a reference signal received power value.

3. The method of claim 1, wherein at least one of the respective signal strengths comprises a received signal strength indicator value.

4. The method of claim 1, wherein, when receiving the service request from the user equipment occurs, at least some of the cellular broadband communications are being conducted with the user equipment for usage of a first application of the user equipment, wherein the service request corresponds to a second application of the user equipment, and wherein at least one of the respective signal strengths comprises a signal-to-interference and noise ratio value.

5. The method of claim 1, wherein the machine learning model is trained to favor decreasing the energy efficiency metric of the system while satisfying the resource allocation of the system.

6. The method of claim 1, wherein the machine learning model is trained to determine the selected radio access technology based on a service level agreement that corresponds to a performance metric applicable to the cellular broadband communications.

7. The method of claim 1, wherein the cellular broadband communications are first cellular broadband communications, and further comprising:
updating the offline trained machine learning model according to online reinforcement learning based on feedback resulting from in-field operations of conducting second broadband cellular communications.

8. The method of claim 1, wherein the machine learning model is trained to determine the selected radio access technology based on satisfying at least one of a requested quality-of-service metric associated with the user equipment, a data rate associated with the user equipment, or a contract associated with the user equipment.

9. A system, comprising:
a processor; and
a memory that stores executable instructions that, when executed by the processor, facilitate performance of operations, comprising:
receiving a service request from a user equipment, wherein the service request corresponds to facilitating cellular broadband communications;
based on the service request, determining respective signal strengths of respective radio access technologies of a group of multiple radio access technologies usable for the cellular broadband communications;
identifying a subset of the respective radio access technologies for which corresponding signal strengths satisfy a signal strength criterion;
processing the corresponding signal strengths of the subset of the respective radio access technologies with a trained machine learning model to determine a selected radio access technology of the group of multiple radio access technologies, wherein the trained machine learning model is configured to determine the selected radio access technology based on an energy efficiency metric of the system and based on resource allocation of the system; and
communicating with the user equipment using the selected radio access technology.

10. The system of claim 9, wherein the trained machine learning model is a pre-trained machine learning model, and wherein the operations further comprise:
training a machine learning model to produce the pre-trained machine learning model according to a single-agent reinforcement learning process, wherein a state space of the single-agent reinforcement learning process comprises the group of multiple radio access technologies, respective power consumption values of respective multiple radio access technologies of the group of multiple radio access technologies, and respective channel resources of the respective multiple radio access technologies.

11. The method of claim 9, wherein the operations further comprise:
maintaining a data store that comprises respective transmission thresholds for the respective radio access technologies, and respective target spectral efficiencies of the respective radio access technologies; and
wherein determining the selected radio access technology of the group of multiple radio access technologies is based on determining that the selected radio access technology is configured to schedule the user equipment to use the selected radio access technology to achieve a requested throughput.

12. The system of claim 10, wherein the operations further comprise:
in response to an update criterion being determined to be satisfied, updating the respective transmission thresholds for the respective radio access technologies based on information received from respective link adaptation components of the respective radio access technologies.

13. The system of claim 9, wherein the selected radio access technology is a first selected radio access technology, and wherein the operations further comprise:
after determining the selected radio access technology of the group of multiple radio access technologies, determining, by the system and with the trained machine learning model, a second selected radio access technology of the group of multiple radio access technologies, wherein the second selected radio access technology corresponds to a better energy efficiency criterion with respect to the user equipment than the first selected radio access technology; and
transferring the user equipment from the first selected radio access technology to the second selected radio access technology.

14. The system of claim 9, wherein the operations further comprise:
training a machine learning model to produce the trained machine learning model according to a reinforcement learning process, wherein the reinforcement learning process is configured to receive a positive reward when an energy consumption associated with a state of the reinforcement learning process is less than an average energy efficiency for a load, and wherein the reinforcement learning process is configured to receive a negative reward when the energy consumption associated with the state of the reinforcement learning process is greater than the average energy efficiency for the load.

15. A non-transitory computer-readable medium comprising instructions that, in response to execution, cause a system comprising a processor to perform operations, comprising:
based on receiving a service request from a user equipment, determining respective signal strengths of respective radio access technologies of a group of multiple radio access technologies;
identifying a subset of the respective radio access technologies for which a corresponding subset of the respective signal strengths satisfies a signal strength criterion;
processing the respective signal strengths of the subset of the respective radio access technologies with an artificial intelligence model to determine a selected radio access technology of the group of multiple radio access technologies, wherein the artificial intelligence model is trained to determine the selected radio access technology based on an energy efficiency metric of the system and based on resource allocation of the system; and
communicating with the user equipment using the selected radio access technology.

16. The non-transitory computer-readable medium of claim 15, wherein the artificial intelligence model comprises a group of long-short term memory models, and wherein respective long-short term memory models of the group of long-short term memory models correspond to the respective radio access technologies.

17. The non-transitory computer-readable medium of claim 15, wherein the operations further comprise:
storing respective power consumption models for the respective radio access technologies, wherein the respective power consumption models comprise respective amounts of power consumed in respective low-power states.

18. The non-transitory computer-readable medium of claim 15, wherein the operations further comprise:
storing respective power consumption models for the respective radio access technologies, wherein at least two power consumption models of the respective power consumption models differ in terms of a number of power consumption states.

19. The non-transitory computer-readable medium of claim 15, wherein the respective radio access technologies correspond to use of respective power amplifiers that have different energy consumption, and wherein the artificial intelligence model is configured to perform load balancing amongst the different radio access technologies that comprise the user equipment.

20. The non-transitory computer-readable medium of claim 15, wherein a first base station is configured to provide the group of multiple radio access technologies, and wherein a radio access network intelligent controller is configured to perform load balancing among respective base stations of a group of base stations that comprises the first base station based on current load conditions and a traffic prediction model.
